(19) United States
(12) Patent Application Publication
(10) Pub. No.: US 2005/0083960 A1
(43) Pub. Date: Apr. 21, 2005

(54) Method and apparatus for transporting parcels of data using network elements with network element storage

(75) Inventors: David Gutierrez, Palo Alto, CA (US); Tal Lavian, Sunnyvale, CA (US); Steven K. Merrill, Los Altos, CA (US); Franco Travostino, Arlington, MA (US); Indermohan Monga, Acton, MA (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/719,299

(22) Filed: Nov. 21, 2003

Related U.S. Application Data
(60) Provisional application No. 60/508,523, filed on Oct. 3, 2003.

(51) Int. Cl. H04L 12/54; G06F 15/16; H04L 12/28; H04L 12/56

(52) U.S. Cl. 370/428; 370/395.4; 709/201

(57) ABSTRACT

A network element with network element storage and independent intelligence may be configured to provide temporary mass storage to facilitate the transfer of large files across an optical network. The network element may also be provided with intelligence to enable the network element to maintain a higher level understanding of the data flows. Using network element storage enables network elements involved in data transmission across the network to temporarily store data being transferred on the network. This allows parcels of data to be transmitted part way through the network when a complete path through the network is not available. It also allows data to be aggregated at strategic locations on the network, such as at the location of a transmission bandwidth mismatch, to enable the data to be transmitted over the high capacity optical resource at a higher rate, thus more efficiently utilizing the bandwidth on the higher bandwidth resource.

### CROSS REFERENCE TO RELATED APPLICATIONS

This application is a continuation in part of prior Provisional U.S. Patent Application No. 60/508,523, filed Oct. 3, 2003, the content of which is hereby incorporated herein by reference.

### BACKGROUND

1. Field of the Invention

This application relates to communication networks and, more particularly, to a method and apparatus for transporting parcels of data using network elements with network element storage.

2. Description of the Related Art

Data communication networks may include various computers, servers, nodes, routers, switches, hubs, proxies, and other devices coupled to and configured to pass data to one another. These devices will be referred to herein as “network elements.” Data is communicated through the data communication network by passing protocol data units, such as frames, packets, cells, or segments, between the network elements by utilizing communication links formed according to a conventional technology, such as optical, electrical, or wireless technology. A particular protocol data unit may be handled by multiple network elements and cross multiple communication links as it travels between its source and its destination over the network.

Grid networks is an emerging application that builds overlay networks, i.e. computational Grids, on existing network infrastructures using Grid computing technology. In a Grid network, which forms a virtual organization, Grid nodes are distributed widely and share computational resources such as disc storage, storage servers, shared memory, computer clusters, data mining, and visualization centers, although other resources may be available as well. One example of Grids is the TeraGrid, in which Grid computing technology has been deployed to enable supercomputer clusters distributed in four distant locations in the United States to collaboratively work on computationally intense tasks, such as high-energy physical simulations and long-term global weather forecasting. Other potential uses for Grid computing include genomics, protein structure research, computational fluid dynamics, astronomy and astrophysics, Search for ExtraTerrestrial Intelligence (SETI), computational chemistry, “intelligent” drug design, electronic design automation, nuclear physics, and high-energy physics. Grid computing may be used for many other purposes as well, and this list is not intended to be inclusive of all possible uses.

Some of these applications are capable of producing an incredible amount of data that must be distributed to other Grid applications for analysis. For example, high energy physics may generate more than a petabyte of data (1 petabyte=1000 Terabyte=10¹⁵ bytes). To transfer a petabyte of data over a 10 Gigabit link would take approximately 27.8 hours, assuming 100% throughput, no overhead associated with packet headers, etc., and no network problems. This data must be sent to research facilities and universities around the world for analysis and storage.

When faced with data volumes this large, and data transfer rates this fast, traditional packet switched networks, such as TCP/IP based communication networks, tend to become overloaded and incapable of or inefficient at handling these large data transfers. One technology that is capable of handling these large data transfers is the use of optical networking, which can handle data transfer rates exceeding 10 gigabits per second (Gbps).

There are several interfaces between the optical network and other portions of the network at which there may be a potential transmission rate mismatch. For example, standard computer equipment may not be capable of outputting data at rates as fast as optical networking resources are able to transmit it. Similarly, a bandwidth mismatch may occur where optical networking technology interfaces with other portions of the communication network. For example, assume a network application is interfaced with a 1 Gbps link to an optical network, at which point the traffic is placed onto a 10 Gbps lambda. In a packet-based multiplexed network this is not a problem, since the other 9 Gbps may be occupied by other flows so that the network resource is able to be largely utilized. Where the lambda is a switched resource that has been reserved to carry traffic only for that network application to guarantee its availability, the lower bandwidth feed link acts as a bottleneck that prevents the full capacity of the 10 Gbps lambda from being utilized. This situation is prevalent, for example, where the reserved network bandwidth is a wavelength in a DWDM fiber configured to operate at an OC-192 data transmission rate (10 Gbps). Thus, a large amount of bandwidth may be wasted due to transmission mismatches between the packet network and the optical underlay network.

Additionally, in some instances, it is desirable to send a given large quantity of data to more than one intended recipient. Where the data transmission is performed in a point-to-point manner, this requires the data source to be available for multiple transmission sessions, thus consuming additional data transmission resources.

### SUMMARY OF THE DISCLOSURE

Accordingly, it would be advantageous to provide method and apparatus for transporting parcels of data using network elements with network element storage. For example, according to one embodiment of the invention, a network element with network element storage and independent intelligence may be configured to provide temporary mass storage to facilitate the transfer of large files across an optical network. The network element may be provided with large volume high throughput storage resources (referred to herein as “network element storage”), and intelligence to enable the network element to maintain a higher level understanding of the data flows through the network. In this embodiment, the network element is able to intercept data flows, store the data flows for a predetermined period of time and then transmit the data onward on the network toward the destination. In one embodiment, the network element is disposed on the network adjacent the ingress to the high bandwidth network to enable data to accumulate in the storage resource prior to being transmitted on the high bandwidth network. In another embodiment, the network element is disposed on the network adjacent the egress from the high bandwidth network to enable data to accumulate in the storage resource before being transmitted over a lower bandwidth egress network. Optionally, both embodiments may be utilized together to coordinate transfer of volumes of data through the network and to manage the data flow throughout the data transfer process.

Using network element storage enables network elements involved in the transmission of data across the network to temporarily store the data being transferred on the network. This allows parcels of data to be transmitted part way through the network when a complete path through the network is not available. It also allows data to be aggregated at strategic locations on the network, such as at the location of a transmission bandwidth mismatch, to enable the data to be transmitted over the high capacity optical resource at a higher rate, thus more efficiently utilizing the bandwidth on the higher bandwidth resource.

### BRIEF DESCRIPTION OF THE DRAWINGS

Aspects of the present invention are pointed out with particularity in the claims. The following drawings disclose one or more embodiments for purposes of illustration only and are not intended to limit the scope of the invention. In the following drawings, like references indicate similar elements. For purposes of clarity, not every element may be labeled in every figure. In the figures:

FIG. 1 is a functional block diagram of an example of a communication network according to an embodiment of the invention;

FIG. 2 is a functional block diagram of a network element with network element storage according to an embodiment of the invention; and

FIG. 3 is a functional block diagram of an example of a communication network according to another embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As discussed in greater detail below, a network element is provided with network element storage to enable it to temporarily store parcels of data to be passed through the network. As used herein, the term “parcel of data” will be used to describe a relatively large amount of data that is to be logically treated together and to be passed as a unit through the network from a given starting point to a given end point. The end-points in this context may be applications, or aggregation points associated with multiple applications.

According to one embodiment of the invention, a mechanism is provided to offload the responsibility for transmission of data from end systems to the network itself. This allows data to be transmitted hop by hop, instead of end to end, which increases the flexibility associated with scheduling the use of network resources on the network. According to one embodiment, network elements are provided with a local temporary fast storage (network element storage) to enable data to be delivered intermediately, or partially from its source to its intended destination. In this embodiment, data is transmitted from one hop on the network to another hop on the network and is aggregated until there is enough data to justify delivery to the next hop, until all of the data is received, or until the data is scheduled to be transmitted to the next hop.

For example, in an aggregation point configured to aggregate traffic from a 1 Gbps link to a 10 Gbps link, the data from the 1 Gbps link may be stored in a network element with network element storage and, when the 10 Gbps link becomes available, the data may be moved in one tenth of the time over the higher bandwidth link. By providing a mechanism to temporarily store the data at the bandwidth mismatch, the higher bandwidth network resource may be reserved for only a portion of the time the lower bandwidth is reserved, and need not be available at all during the transmission over the lower bandwidth link. This mechanism thus separates the need to allocate high bandwidth all the way through the network and enables transmission even where one part of the transmission path is constricted (of lower bandwidth) or congested (carrying other traffic).

Since data is to be stored on the network, one aspect of the invention includes providing the network element having network element storage with sufficient intelligence to enable it to assume responsibility for transmission of the data. Specifically, in conventional data transfer situations, the end systems are responsible for transmission of the data—the data source is responsible for transmitting all the data and the data target is responsible for receiving all the data and ensuring it has been provided with a copy of all the data. In this embodiment, however, since the network element will be intercepting the data prior to reception by the data target, the network elements involved in the transfer, or a centralized network transfer service, are provided with intelligence to enable the data transfer to be managed by the network elements on behalf of the end applications.

According to one embodiment of the invention, the network element associated with the network element storage is provided with the intelligence of an end-system to enable it to take responsibility for the completion of delivery of the data in the data transfer. A simple example of this would be for the end system to offload the responsibility to an edge device having network element storage facilities. Upon completion of the transfer of responsibility, the edge device will emulate the end system for further transactions involving the data until data delivery is completed or until it transfers responsibility to another subsequent network element.

The network element with network element storage may include intelligence to enable it to make filtering decisions based on its understanding of the traffic flows. Thus, the network element may be configured with the attributes of a content switch to understand layer 4-7 aspects of flows on the network.

The network element may also include one or more TCP/IP Offload Engines (TOEs), such as may be found in a Network Interface Card (NIC) or a Storage Network Interface Card (SNIC). TCP/IP processing is very CPU intensive, involving a series of acknowledgments, interrupts, data copying, and caching. A TOE enables this functionality to be offloaded from the main processor to an ASIC to remove much of the complex nature of the TCP/IP protocol processing from the network element's CPU. This frees up the CPU to handle other aspects associated with network packet or parcel processing.

The network element may also include an emulation module configured to reside between the data source and data target, and emulate both of them without letting either the data source or the data target know they are not talking directly to each other. This may involve TCP splicing plus application level mechanisms to enable the emulation module to splice a TCP flow from the data source with a TCP flow to the data target, as well as to enable the network element to understand the nature of the communications occurring between the data source and data target.

To accommodate the incoming data, the network element should be provided with very fast, large, secondary storage. Such fast, large, secondary storage is currently available in the form of inexpensive fast storage bricks capable of handling up to 1 Gbps sustained access time. Any form of storage may be used that is sufficiently fast and large to handle the anticipated data storage requirements of the network element and the invention is not limited to implementation of any particular type of storage. This network element storage may be configured using any one of a number of Redundant Array of Independent Discs (RAID) techniques, such as using disc striping to enable data to be simultaneously written to or read from multiple discs simultaneously. This enables the storage delivery speeds to be increased as well as provides redundancy to the stored data to allow for data recovery in the event of a fault on one or more of the discs.

A network element configured in this manner, with network element storage, may be useful in connection with moving very large files, i.e. files containing multi-terabytes of information, across the Internet. Specifically, providing the network elements with network element storage enables the file to be moved from the data source to one or more intermediate devices before reaching the data target. As used herein, the term “parcel switching” will be used to refer to the notion of moving a file part way through the network and pausing at one or more intermediate nodes on the network.

The network element having network element storage may also advantageously be utilized at an interface between a packet switched network and a circuit switched network. Specifically, on a circuit switched network, the entire capacity of a given link is reserved for transmission of a particular flow of data for a particular period of time. By providing network element storage on either side of the reserved link, the link can be used to transmit data in a very efficient manner and be stored at the end points prior to and subsequent to transfer. This allows the data to arrive at the ingress to the circuit network and stored prior to transmission over the circuit network to enable a higher bandwidth on the circuit network to be utilized. Additionally, this allows the data to be stored upon receipt at the end of the circuit network and prior to transmission onto the packet-based network. This is advantageous, since providing a very large burst of packets onto the packet-based network may cause the packet-based network to overload and begin to drop the packets. In connection with this, the traffic that is subsequently placed onto the packet-based network may be done in a manner such that the traffic shaping associated with the transfer maximizes the use of the packet-based network resources while minimizing the likelihood that packets will start to be dropped on the network.

Where the network element storage is included on network devices deployed in a packet-based network, the network element storage may also be used to store packets that otherwise would need to be dropped, for example due to queue overruns and network congestion. These packets can then be transmitted at a later time once the network conditions improve. This allows packets of files that are being parcel-switched to be temporarily placed in the secondary storage rather than being dropped to provide assured quality of service on network elements handling the parcel-switched traffic.

According to one embodiment of the invention, out-of-band signaling is not required to implement transfers of data between network resources. Rather, upon receipt of a flow of data, the network element first attempts to pass it onto a link of equal size on its reservation. If the link is congested, or is of a mismatched size (either too big or too small) the network element will buffer the data in the network element storage. The buffered data will be aggregated and passed together over the attached link if the link capacity is larger than the link which was used to transfer the data to the network element. Similarly, the buffered data will be transferred at the slower rate to the attached link where the link capacity is smaller than the link capacity of the link which was used to transfer the data to the network element.

Because the transfers of large files according to embodiments of the invention involve storing the files intermediate the intended end-points of the transfer, it can be expected that the use of the methods associated with this invention may increase the latency associated with performing a data transfer through the network. Accordingly, time sensitive transmissions may contain an indication that they are to not be stored intermediately by the network elements. Alternatively, non-time sensitive transmissions may be marked as such to enable the network elements to identify those transmissions as potentially being able to benefit from the use of network element storage. Identifying those transmissions as non-time-sensitive may enable the network to optimize transmission through the use of the network element storage to minimize transmission costs associated with the transfer, thus resulting in lowered costs to the network users.

According to an other embodiment, the network elements with network element storage are configured to aggregate file transfers that are not time sensitive and make better use of the bandwidth by making a single circuit reservation for the multiple aggregated file transfers.

The network device with network element storage also may eliminate the need to have all the resources, i.e., data source(s), data target(s), and network elements, all available at the time of the transfer. Rather, as long as the data source and network element are available, the transfer can be initiated by the data source and received by the network element with network element storage. Then, when the network is ready, the data transfer can continue across the network until it reaches a storage node capable of communicating with the data target. When the data target is ready to receive the data transfer, the data transfer can commence. In this fashion large data transfers can take place through a networked environment even where the network resources required to perform the transfer and/or one or more of the participants to the transfer are not presently able to engage in the transfer. This allows for greater flexibility and increased use of allocated bandwidth, which may be of particular importance on networks with limited bandwidth resources.

Embodiments of the invention have been described as having several potential uses and providing several potential benefits. Embodiments of the invention do not need to perform any or all of these enumerated benefits, as the described benefits have been set forth merely as an example of several potential benefits that may be experienced by an embodiment of the invention. Accordingly, the invention may be broader than this and does not require performance of any, some, or all of the advantages set forth herein and associated with a network element with network element storage.

In addition to the use of network elements with network element storage in connection with data intensive applications such as high energy physics, discussed above, embodiments of the invention may find uses in connection with other types of data transfers as well. For example, caching servers are currently deployed throughout the Internet to cache frequently requested information at locations on the Internet closer to the end users. Distribution of content to and between these caching servers, for example where one of the caching servers has experienced a problem and requires its cache to be refilled, may require a large amount of data to be transferred from one location to another. The network elements with network element storage may be useful in connection with these transfers as well, or in connection with any other type of data transfer that is large and not required to occur in real time.

Additionally, in connection with media servers and content distribution networks, transferring the content to an intermediate switch may be of great benefit to alleviate the requirement that the content distribution network service numerous simultaneous end users. Replication of the content at the intermediate network element with network element storage may be advantageously employed in this context to enable content replication to occur without direct intervention from the content distribution network.

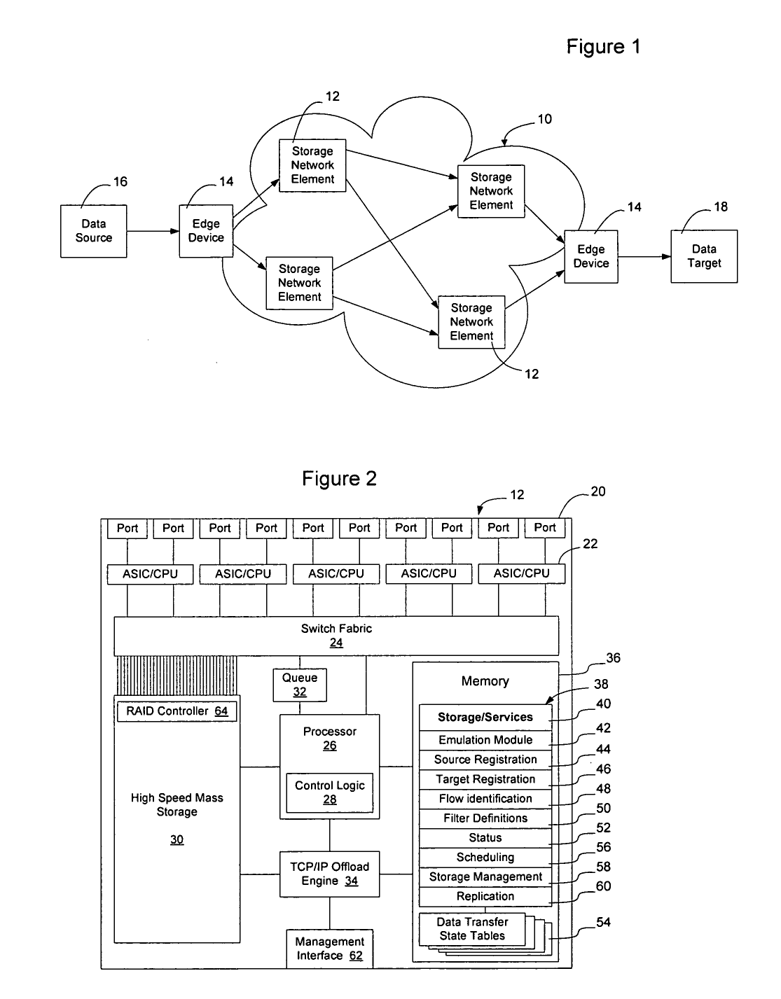

FIG. 1 illustrates one embodiment of a network 10 having storage enabled network elements 12. Edge devices 14 are provided at the edge of the network to interface with end systems comprising the data source 16 and data target 18 for a parcel-switched data transfer. In the embodiment illustrated in FIG. 1, the storage elements in the core of the network 10 are illustrated as having network element storage. The invention is not limited to this embodiment as the network element storage may be deployed elsewhere as well, for example in connection with the network elements forming the edge network devices 14. Additionally, not all network elements need to be provided with network element storage.

In operation, the data source 16 will initiate a transfer of a parcel of data to the data target, or a client application may request the transfer of a data set from the data source to the data target. A number of reservations may take place in connection with this and the invention is not limited to any particular reservation scheme associated with facilitating the transfer of data. The edge device receives the data and, since in this embodiment the edge device is not provided with network element storage, the edge device forwards the data on to one of the storage network elements. Routing algorithms in the core may be used to determine the path the packets will take through the network core.

If the link from the first storage network element to the next storage network element is not available, of the wrong size, or otherwise does not contain ideal transmission characteristics, the storage network element may cause the data to be placed in its network element storage resources for later transmission. This process takes place throughout the network until the data is passed through the edge device 14 to the data target 18.

FIG. 2 illustrates one embodiment of a network device with network element storage 12. In the embodiment illustrated in FIG. 2, the network element storage is illustrated as being part of the network element. The invention is not limited to this embodiment as external storage interfaced to the network element or storage connected to a storage area network and interfaced to the network element may be used as well.

In the embodiment illustrated in FIG. 2, the network element includes a number of ports 20 configured to transmit and receive data on a communication network. The data received on the ports is optionally processed by ASIC/CPUs 22 and then passed to a switch fabric 24. The switch fabric 24 is controlled by a processor 26 containing control logic 28. As shown in FIG. 2, high speed mass storage 30 may be connected to the switch fabric so that packets may be stored for later transmission by the network device. Optionally, a queue 32 may also be provided to store packets temporarily while the disposition of those packets is being ascertained by the processor 26. Optionally, a TCP/IP Offload Engine (TOE) 34 may be included to accelerate TCP/IP packet processing.

The network element has a native or interfaced memory 36 containing data and instructions to enable the processor to implement the functions ascribed to it herein. For example, the memory may contain data transfer software 38 containing data and instructions to enable the control logic to perform the functions and operations ascribed to a network element with network element storage described above. The data transfer software 38 may include multiple submodules configured to perform specific functions. For example, the data transfer software may include a storage/services module 40 configured to interact with applications on the network to handle communications relating to storage and parcel data transfer on the network. An emulation module 42 may be provided to facilitate emulation of the network element to the data source and data target where that is advantageous to facilitation of the parcel transfer.

Another module may be a source registration module 44 to enable a data source to register with the network element in connection with a data transfer, and a target registration module 46 to enable a data target to register with the network element in connection with the data transfer. Source and target registration may be advantageous where the data is to be transferred according to a particular rate, with particular priority, or according to any other particular parameters.

A flow identification module 48 may be used in connection with a filter definition module 50 to enable the network element to identify packets associated with the parcel transfer. This is particularly useful where the parcel transfer is to at least partially take place over a packet switched network. A status module 52 may keep track of parcel transfers so that data source and data target clients may obtain information about the progress of the transfer, the estimated time of completion, and any other information of interest to the client applications. Data transfer state tables 54 may be updated to enable the network element to maintain state information associated with data transfers being handled by the network device.

A scheduling module 56 may be used to interact with other network scheduling constructs to enable the network element to obtain bandwidth on a network link or through other network elements in connection with transmission of the parcel of data. This module may operate in connection with a storage management module 58 to organize information within the high speed mass storage 30 to transfer data over reserved network resources in an appropriate fashion.

A replication module 60 may also be provided to enable the content to be replicated on the network. Replication in this context may include header replacement, content replication, and other several sub-modules configured to facilitate content replication on the network.

Optionally, a management interface 62 may be provided on the network element to enable the network element to be controlled by a network manager. Other functional modules such as a protocol stack (not shown) and a raid controller 64 may be provided to enable the network element to perform specified functions and otherwise interact on the network.

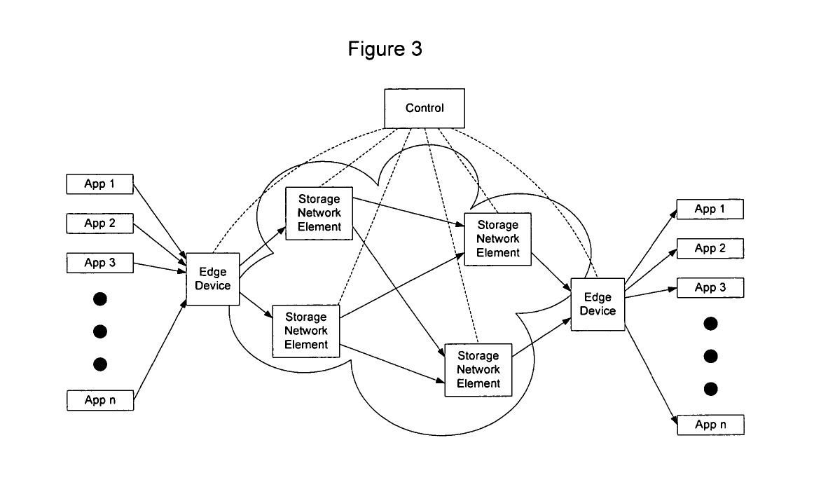

Although the previous description has focused on using a network element with network element storage to transmit data from one data source to one data target, the invention is not limited to this embodiment as this simple example was provided merely to illustrate one application of the invention in an example scenario. The network element storage and method of using the network element storage to facilitate data transmission through a network extends well beyond this one example embodiment. For example, FIG. 3 illustrates an embodiment of a network in which network element storage is used to aggregate traffic from several applications, multiplex that traffic through the use of network element storage, and pass that traffic as a parcel through the network to associated applications.

The applications may be data sources and targets, or other constructs on the network. Enabling the aggregation of data from multiple data sources allows the network element with network element storage to act as an aggregation point for collecting portions of a data set from disparate data sources and presentation of that data to one or more data targets as a single logical data set.

Additionally, enabling the network element with network element storage to be used to transmit a stored data set to multiple data targets enables the data source to offload responsibility for transmission of large quantities of data to the network simply by transmitting the data set to a network element with network element storage. This enables the data source resources to be freed up to perform other functions and minimizes the bandwidth required on the link connecting the data source to the network element with network element storage.

FIG. 3 also illustrates a central control configured to interact with the network elements with network element storage 16 and optionally other network elements, such as edge devise 14 to coordinate transfer of parcels on the network 10. The central control may be configured as shown in FIG. 4 or in another manner to enable it to interact with network elements and schedule transfers of parcels on the network.

The control logic 28 may be implemented as a set of program instructions that are stored in a computer readable memory within the network element and executed on a microprocessor, such as processor 26. However, in this embodiment as with the previous embodiments, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described herein may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method of transporting a parcel of data by an intermediate network element, the method comprising the steps of:
engaging in a protocol exchange with at least one of a data source and a data target to schedule at least one of receipt of the data parcel from the data source and transmission of the data parcel to the data target;
receiving for forwarding the parcel of data by the intermediate network element having network element storage;
storing the parcel of data in the network element storage in coordination with at least one of said data source and data target; and
forwarding the parcel of data.

2. The method of claim 1, wherein the parcel is larger than 1 Gigabyte of data.

3. The method of claim 1, wherein the step of receiving for forwarding takes place by receiving the parcel from a first link with a first bandwidth, wherein the step of forwarding takes place by transmitting the parcel of data on a second link with a second bandwidth, and wherein the first bandwidth is greater than the second bandwidth.

4. The method of claim 1, wherein the step of receiving for forwarding takes place by receiving the parcel from a first link with a first bandwidth, wherein the step of forwarding takes place by transmitting the parcel of data on a second link with a second bandwidth, and wherein the second bandwidth is greater than the first bandwidth.

5. The method of claim 1, wherein the step of storing the parcel of data allows data from the parcel of data to accumulate in the network element storage for more efficient subsequent transmission during the step of forwarding the parcel of data.

6. The method of claim 1, wherein the step of forwarding the parcel causes the parcel of data to be transmitted toward the data target, and wherein the method further comprises the step of forwarding the parcel of data toward a second data target.

7. The method of claim 1, wherein the step of engaging in a protocol exchange enables the network element to participate in control of the data transmission between the data source and data target.

8. The method of claim 1, wherein the step of engaging in a protocol exchange comprises coordinating the transfer of the parcel of data between the data source and data target.

9. The method of claim 1, wherein the step of engaging comprises managing the transfer of the parcel of data between the data source and data target.

10. A network element with network element storage, comprising:
network element storage configured to store data semi-permanently on the network; and
control logic configured to facilitate transmission of a parcel of data from a data source to a data target by causing the parcel of data to be stored intermediate the data source and data target; and
control logic configured to interface with at least one of another network element, the data source, and the data target, to participate in the transmission and storage of the parcel of data intermediate the data source and data target in connection with a transmission of the parcel of data from the data source to the data target.

11. The network element of claim 10, further comprising ports configured to receive transmissions and a switch fabric configured to transmissions between the ports.

12. The network element of claim 10, wherein the control logic is further configured to implement an emulation module to enable it to emulate at least one of a data source and a data target.

13. The network element of claim 10, wherein the control logic is further configured to provide status information to at least one of the data source and data target, said status information being associated with the transfer of the parcel of data through the network.

14. The network element of claim 10, wherein the control logic is further configured to replicate data for transmission to more than one data target.

15. The network element of claim 10, wherein the control logic is further configured to schedule a transfer of the parcel of data between at least one of the data source and network element, and the network element and the data target.

16. The network element of claim 10, wherein the control logic is further configured to identify the parcel of data from flows on a communication network.

17. The network element of claim 10, wherein the control logic is further configured to perform at least one of source registration and target registration.
